(19) United States
(12) Patent Application Publication
(10) Pub. No.: US 2009/0292674 A1
(43) Pub. Date: Nov. 26, 2009

(54) PARAMETERIZED SEARCH CONTEXT INTERFACE

(75) Inventors: Ali Dasdan, San Jose, CA (US); Santanu Kolay, San Jose, CA (US); Amit Kumar, San Jose, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/125,445

(22) Filed: May 22, 2008

(51) Int. Cl. G06F 7/00; G06F 17/30

(52) U.S. Cl. 707/3; 707/E17.014

(57) ABSTRACT

Disclosed are apparatus and methods for facilitating search queries via a computer network. In certain embodiments, each search term that a user inputs for a search query causes a rich set of contextual information having one or more parameters or facets to be presented to the user to further enhance and refine the search query. The context facets can pertain to the search term itself or contextual information that is associated with search results objects that have been previously associated with such search term. Additionally, the user can be queried for a facet to be associated with the search term. The user can then input parameter values or choose selection option (e.g., numbers, strings, links, etc.) for each facet, and search results can then be provided based on such facet parameter values or selection option input.

### BACKGROUND OF THE INVENTION

The field of the invention includes search services provided over a computer network. The field especially pertains to providing an interface for a search query.

In recent years, the Internet has been a main source of information for millions of users. These users rely on the Internet to search for information of interest to them. One conventional way for users to search for information is to initiate a search query through a search service's web page. Typically, a user can enter one or more search term(s) into an input box on the search web page and then initiate a search based on such entered search term(s). In response to a query, a web search engine generally returns an ordered list of search result documents. The list of search results may include a title, a universal resource locator (URL) link, and an abstract.

FIG. 1 is a screen shot showing a portion of a search web page 100 in which a search query has been initiated by entering the search term “orange” into search input box 102 and, in response, a list of search results 104 have been presented based on such search term “orange” 102. As shown, each entry in the list of search results 104 typically includes a title (e.g., title 106a and 106b), a universal resource locator (URL) link (e.g., 110a and 110b), and an abstract (e.g., 108a and 108b).

A user will typically views and possibly clicks on one or more of the presented search results 104 based on the abstracts 108 or titles 106. If the search results do not satisfy the user's need, the only option for the user is to refine the search query by syntactic changes, such as adding or deleting search terms. For example, the user may add the search term “navel” to the previous search term “orange.” If the search term is ambiguous, like the term “navel”, then the search engine may again produce search results that do not meet the user's needs. Thus, it would be beneficial to provide improved mechanisms for facilitating a search query.

### SUMMARY OF THE INVENTION

Accordingly, apparatus and methods for facilitating search queries via a computer network are provided. In certain embodiments, each search term that a user inputs for a search query causes a rich set of contextual information having one or more parameters or facets to be presented to the user to further enhance and refine the search query. The context facets can pertain to the search term itself or contextual information that is associated with search results objects that have been previously associated with such search term. Additionally, the user can be queried for a facet to be associated with the search term. The user can then input parameter values or choose an selection option (e.g., numbers, strings, links, etc.) for each facet, and search results can then be provided based on such facet parameter values or selection option input.

In one embodiment, a method of facilitating search queries via a computer network is disclosed. After a user enters one or more search terms, one or more search facets and a plurality of selection options related to each facet are obtained based on the one or more search terms. Each obtained facet pertains to a specific characteristic type for the one or more search terms, and each related selection option corresponds to a specific value for the specific characteristic type. The one or more obtained facets and related selection options are provided to the user so the user can select one or more selection options for the one or more search terms. When a search is initiated and at least one selection option has been selected by the user, search results are provided based on the search terms and such at least one selection option that is selected by the user.

In a specific implementation, obtaining the one or more facets and related selection options includes one or both of the following: (i) querying the user for a new facet and, in response, receiving a new facet and a related new selection option from the user, or (ii) querying the user for a new selection option for an available facet and, in response, receiving a new selection option for the available facet. In a further aspect, an association between the one or more search terms and the new selection option and the related available or new facet that are received from the user is retained. For a subsequent search query, one or more search facets and a plurality of selection options related to each facet are obtained based on the one or more search terms. The obtained search facets for the subsequent search include the retained new selection option and the related available or new facet. For the subsequent search query, the one or more facets and related selection options, which were obtained for the subsequent search query, are provided to the user so the user can select one or more of the provided selection options. When a search is initiated and at least one selection option has been selected by the user for the subsequent search, search results are provided based on the search terms and such at least one selection option that is selected by the user for the subsequent search. In a further aspect, the retained new selection option and its related new or available facet are also associated with the user and only provided for the subsequent search if the subsequent search is performed by a same user as associated with the retained new selection option. In another further aspect, a plurality of facets and associated selection options are obtained and shared for a plurality of users so as to improve search queries performed by such users

In another specific implementation, the one or more facets and/or one or more selection options are obtained from metadata, a data structure, or a format that was previously associated with the one or more search terms or one or more search results that are related to the one or more search terms. In another embodiment, the one or more facets and/or one or more selection options are obtained from a context of a vertical search for which the search terms are being entered. In yet another embodiment, the one or more facets and/or one or more selection options are obtained from one or more databases that associate the one or more search terms with one or more facets and/or selection options. In another feature, at least one selection option is in the form of a link for a related facet. In a further aspect, the link is an advertisement link and its related facet pertains to an advertisement category. In another aspect, the obtained one or more facets and one or more selection options are associated with one or more of the search results. In yet another embodiment, the obtained one or more facets and the selection of one or more associated selection options are used for search term advertisement targeting.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 is a screen shot showing a portion of a search web page in which a search query has been initiated and a list of search results have been presented based on such search query.

FIG. 2 illustrates an example network segment in which the present invention may be implemented in accordance with one embodiment of the present invention.

FIG. 3 is a flow chart illustrating a process for providing a contextual search interface in accordance with one embodiment of the present invention.

FIG. 4 illustrates a screen shot of a provided contextual search interface in accordance with a specific implementation.

FIG. 5A illustrates an example context data structure for associating a search term with a facet and related selection options in accordance with one embodiment of the present invention.

FIG. 5B illustrates an example search database in accordance with one implementation of the present invention.

FIG. 5C is a diagrammatic representation of a web document with a structured format from which facets and selection options may be determined for related search terms.

FIG. 6 illustrates an example computer system in which specific embodiments of the present invention may be implemented.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, search interface mechanisms are provided for a user to select or input one or more facets and/or one or more related selection options for a search query. Facets and related selection options are obtained and provided to the user so as to enhance the particular set of search terms that are being input by the user. The facets and related selection options may take any suitable form that may enhance a search query. The facets may relate to specific categories or characteristic types that have been previously associated with a particular search term. The selection options may pertain to specific values for the specific characteristic types. For example, facets for a search term “computer” may include brand, computer type, price range, speed, memory size, etc. Example selection options for the facet computer type may include desktop, laptop, etc. Thus, when a user inputs a search term “computer”, he may be presented with the facet “computer type” and selection options “desktop” and “laptop.” Other facet types and related selection options may be utilized as, for example, described further herein.

The facets and related selection options are provided so that the user can select one or more of the selection options that are associated with the search query (or provide new selection options and facets). If the user selects one of these facet selection options, e.g., desktop (or provides a new facet and selection option), a search may then be based on the user's selected option, e.g., “desktop”, as well as the associated search query terms.

Example embodiments of the present invention may be used to significantly enhance the search interface experience by adding new facet parameter controls. In certain embodiments, users can create and save their own rich interfaces for later searches to thereby continue to improve search results relevancy.

Although certain embodiments are described herein in relation to a search query interface for web documents or objects in the context of a general web search service application, it should be apparent that a contextual search interface may also be provided in other applications, such as a music or video service for browsing or searching through audio visual objects. It should also be noted that embodiments of the invention are contemplated in which the operation of the underlying search interface is largely unaffected by the overlying contextual interface. For instance, when a user chooses one or more of the provided selection options for one or more specific facets (or provides their own selection options and/or facets), the search query can be altered using the user's selection option input and then serve as input to the underlying search engine without altering the function of such search engine. However, embodiments are also contemplated in which the operation of the underlying search engine is altered based on contextual information in some way to enable at least some further search enhancements. For example, the search engine may be revised based on the contextual information.

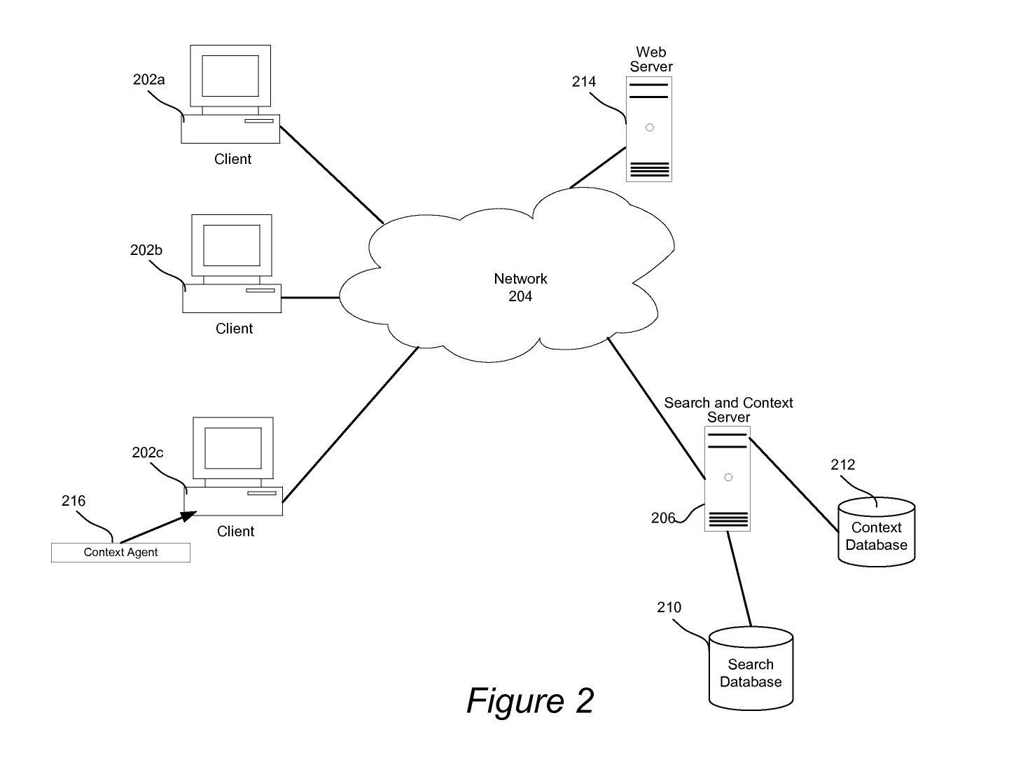

Prior to describing mechanisms for providing a contextual search interface, a search and web architecture will first be briefly described to provide an example context for practicing techniques of the present invention. FIG. 2 illustrates an example network segment in which the present invention may be implemented in accordance with one embodiment of the present invention. As shown, a plurality of clients 202 may access a search application, for example, on search and context server 206 via network 204 and/or access a web service, for example, on web server 214. The network may take any suitable form, such as a wide area network or Internet and/or one or more local area networks (LAN's). The network 204 may include any suitable number and type of devices, e.g., routers and switches, for forwarding search or web object requests from each client to the search or web application and forwarding search or web results back to the requesting clients.

The invention may also be practiced in a wide variety of network environments (represented by network 204) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A search application generally allows a user (human or automated entity) to search for information that is accessible via network 204 and related to one or more search terms. The search terms may be entered by a user in any manner. For example, the search application may present a web page having any input feature to the client (e.g., on the client's device) so the client can enter one or more search term(s). In a specific implementation, the search application presents an input box into which a user may type any number of search terms. Embodiments of the present invention may be employed with respect to any search application, and example search applications include Yahoo! Search, Google, Altavista, Ask Jeeves, etc. The search application may be implemented on any number of servers although only a single search server 206 is illustrated for clarity and simplification of the description.

The search and context server 206 (or servers) may have access to one or more search database(s) 210 into which search information is retained. For example, each time a user initiates a search query with one or more search terms and/or performs a search based on such search query, information regarding such search may be retained in the search database(s) 210. For instance, the user's search request may contain any number of parameters, such as user or browser identity and the search terms, which may be retained in the search database(s) 210. Additional information related to the search, such as a timestamp, may also be retained along with the search request parameters. When results are presented to the user based on the entered search terms, parameters from such search results may also be retained. For example, the specific search results, such as the web sites, the order in which the search results are presented, whether each search result is a sponsored or algorithmic search result, the owner of each search result, whether each search result is clicked by the user, and a timestamp may also be retained in the search database(s) 210.

In addition to information regarding search queries, embodiments of the present invention may utilize information that is collected when users access web objects, e.g., web pages, via one or more web services. In a specific implementation, one or more clients may be configured with a context agent, e.g., 216 of FIG. 2. The context agent may be configured to intercept requests from the client for any web object, such as a web page to a particular service provider, before forwarding such request to its service provider. For instance, the client browser may include a plug-in context agent that receives URL (universal resource locator) requests made by the user for particular web pages. The context agent then receives the web object, e.g., web page, which was received from the service provider in response to the web object request. The context agent may also be configured to retain data regarding the web object, such as an identification of such object (e.g., URL), click queries (queries for which the web object's URL was clicked, view queries (queries for which the web object's URL was viewed, e.g., in a list of search results), user tags, and timestamps for accessing and exiting such object. This information may then be forwarded to a central server, such as search and context server 206 and retained in a central database, such as search database 210. The retained search information may later be used to affect certain aspects of the present invention.

The search and context server 206 may also be configured to provide one or more context facets and related selection options to the user for inputting along with the search terms. Alternatively, a separate context server may be utilized. Context facets and related selection options may be obtained by the search and context server 206 in any suitable manner (for example, from the user, previous users, or analysis of one or more data sources, such as databases, owned and operated by the same company or different companies) as described further herein. The obtained context facets and related selection options may be stored, for example, in context database 212 or any other suitable storage device. The obtained context facets and related selection options may be retained in association with one or more search terms, search results, and/or users.

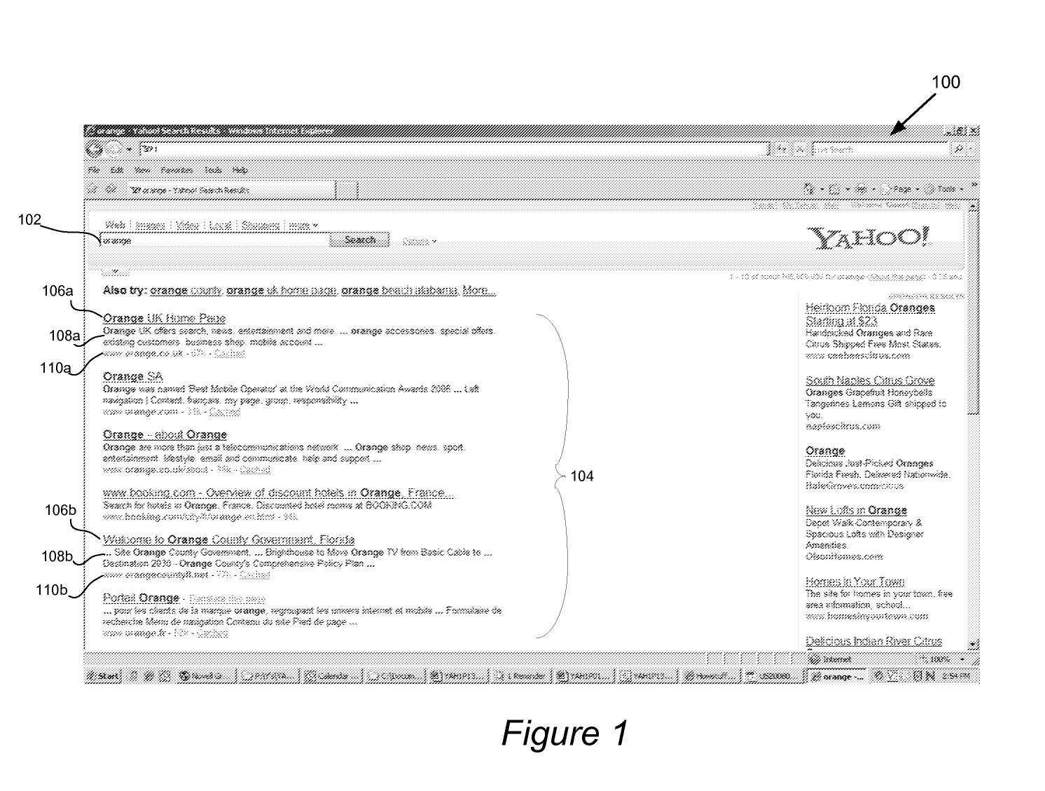

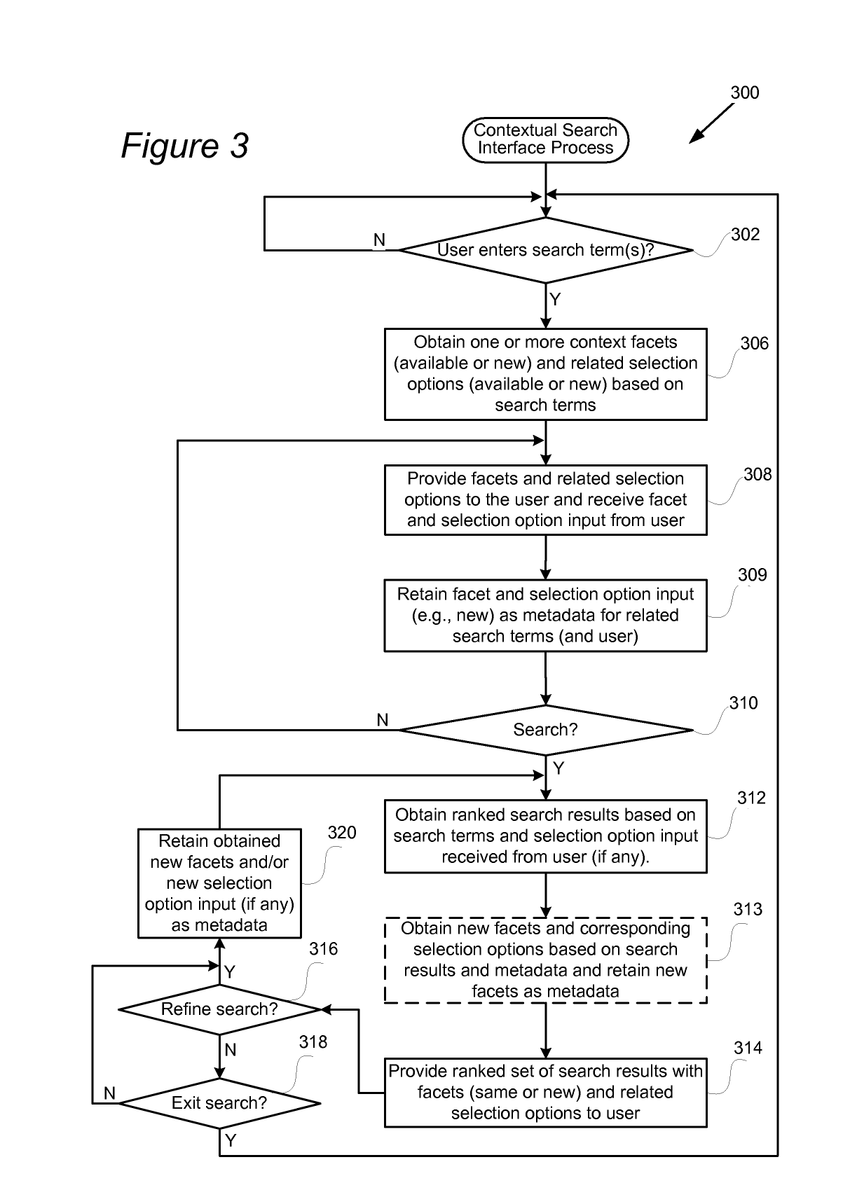

Regardless of the specific architecture, any suitable mechanism for allowing users to utilize context facets and related selection options for a search query may be provided. FIG. 3 is a flow chart illustrating a process 300 for providing a contextual search interface in accordance with one embodiment of the present invention. Certain embodiments of the present invention are triggered as a user enters search terms for a search query. Accordingly, it may be initially determined whether a user has entered one or more search terms in operation 302. For instance, the user has entered one or more search terms into a search input box, such as search input box 102 of FIG. 1.

If search terms are not being entered, the process may continue to wait. When one or more search terms are being entered (or have been entered), one or more context facets and related selection options may then be obtained based on the entered search terms in operation 306. As described further below, for example, the facets and selection options may be obtained from the user, from a database, from a data analysis process, or from any suitable source. The obtained facets and related selection options may be provided to the user in operation 308. Facet and selection options input may also be received from the user in operation 308. For example, the user can provide input by choosing an available selection option of an available facet, providing a new selection option for a new facet, or providing a new selection option for an available facet, for example, as described further below.

In a specific implementation, multiple dimensions or facets are obtained or determined for each search term. The facets can serve to conceptually divide a general category for the search term into a plurality of specific sub-categories or facets. Each sub-category can also be divided into a plurality of sub-categories or facets. A search term may be defined by any number and level of sub-categories and may depend on one or more preferences of one or more search users and/or one or more search administrators. For example, as users continue to utilize context facets, unpopular facets can be discarded and users can add preferred facets to be associated with particular search terms and/or search results. Regardless of source, obtained facets can be presented to users, for example, near or adjacent to the search input area as described further below, for example.

Selection options allow a user to select one or more values for each related facet. For instance, when a search term is divided into a number of categories, the user can select a value for each category or facet so that the search can be directed towards such specific facet values.

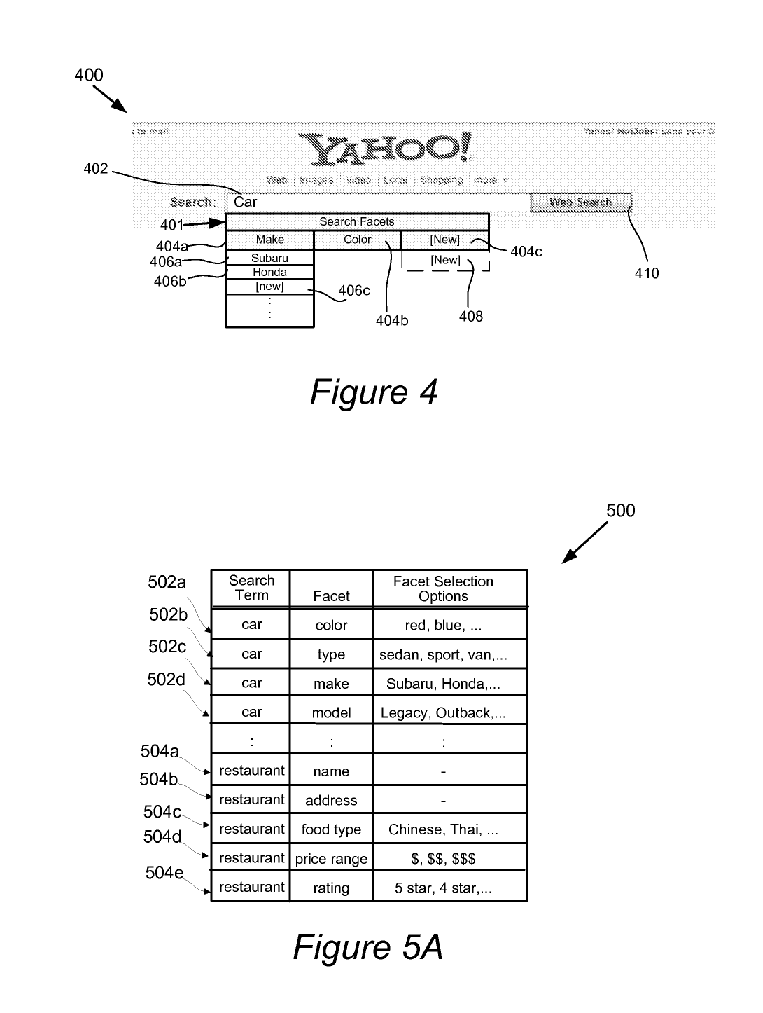

FIG. 4 illustrates a screen shot of a provided contextual search interface 400 in accordance with a specific implementation. The search facets and related selection options are preferable provided near or adjacent to an area in which the user is entering search terms. Search facets and related selection options can be provided in a static or dynamic format. As shown, search facets 401 are presented in a dynamic format in an area below the search input box 402, into which the user has entered search term “car”. In this facet example, each facet is associated with a pull-down menu so that selection options can be dynamically shown for each facet by selecting a facet and accessing its pull-down selection options. As shown, the selection options 406 for a “make” facet 404a are being pulled down by the user, while selection options for a color facet 404b are hidden. Alternatively, the obtained facets and their related selection options may be presented statically as a unit.

The provided facets may generally include relevant dimensions of the entered search terms. In the illustrated example for search term “car”, the facets include “make” facet 404a and “color” facet 404b. Although any suitable number and type of facets may be provided, only two facets are illustrated in FIG. 4.

The provided or presented facets may merely include a predefined number of the obtained facets, e.g., the most popular or relevant facets. For example, the facets that were most frequently selected by a particular user, a set of users, or any user in previous search queries may be selectively provided. In another example, the particular facets and selection options may be predefined as most relevant for a particular search term, and a predefined number of these most relevant facets and selection options are then selectively provided for such search term.

Selection options input may be received from the user in any suitable manner. The user may select from a set of available options or define new selection options for an available facet or a newly defined facet. For example, the user may select from an available “Subaru” option 406a, an available “Honda” option 406b, etc. for the “make” facet 404a. Likewise, different available color options (e.g., red, blue, yellow, gold, etc.) may be accessed and selected by a user via a pull-down menu (not shown) for the “color” facet 404b. A user may also choose to enter a new selection option for an available facet. For instance, a user may enter a new selection option, e.g., Mitsubishi, for the “make” facet 404a by entering the selection value input “Mitsubishi” into empty or [new] option area 406c. Alternatively, a user may enter a new facet, which is not currently presented, into empty or [new] facet area 404c, and then enter a new selection option into empty or [new] option area 408 for such new facet 404c. For example, the user may wish to add a car type facet and enter a value of “sedan” for this new car type facet.

Said in another way, facets and related selection options may be obtained from the user, for example, by receiving a new facet input or a new selection option input for an available facet in response to querying for such new facet or new selection option, e.g., by providing new facet input area 404c or new selection option area 406b. Selection option input may also be received from the user by the user selecting an available selection option from an available facet.

Referring back to FIG. 3, facet and selection option input e.g., newly received facets and selection option input, may be retained as metadata for the related search terms in operation 309. For example, an association between the current search terms and the new selection options and the related available or new facet, which are received from the user, is retained in one or more databases, e.g., context database 212. The facets and selection options may also be associated with the particular user, e.g., who entered the new facet and/or selection option. User selection of available selection options may also be retained as metadata for the related search terms (and user).

It may be determined whether a search has been initiated in operation 310. For example, the user may select an input mechanism, e.g., search button 410 of FIG. 4, to initiate a search based on the already entered search words and/or any selection options input and related facets. After a search has been initiated, ranked search results may then be obtained based on the search terms and selection option input received from the user (if any) in operation 312. The ranked search results may be obtained by simply inputting the search terms and text for the selection option input into a search engine.

In an alternative approach, if a particular search result has a menu structure that corresponds to at least a subset of the facets, the particular search result may be provided after the selection option input for such facet subset has been input for the particular search result. For example, an auto buying web page may include one or more menus for entering car type, price, color, etc., and a user has entered the search term “car” and selection option inputs of sedan, under $10,000, and red for the corresponding facets for car type, price, and color. These selection option inputs can then be input into the auto buying web page before providing the web page as a search result.

Optionally, new facets and related selection options may be obtained based on the provided search results, as well as metadata for same, in operation 313. For instance, new facets and/or selection options may be determined based on an analysis of the metadata of the obtained search results. The new obtained facets for the search results may also be retained in operation 313. The ranked set of search results may then be provided, with the facets (same and new) and related selection options to the user, in operation 314. For instance, the search facets 401 and input area 402 of FIG. 4 may be provided with the search results (not shown) so to allow the user to refine the search results. That is, the user can continue to select additional selection options and enter new facets or selection options to refine his/her search.

After search results are provided, it may be determined whether the search is to be refined by the user in operation 316. For instance, the user may select additional or different selection options for the same or new facets. The user may also enter additional search terms or other search parameters. If the search is not being refined, it may be determined whether the search is being exited in operation 318. If an exit has occurred, the contextual search interface procedure may be reinitiated and return to operation 302. If the search is not being exited, the process may continue to check for a search refinement in operation 316.

If a search refinement has occurred, new facets (if any) and/or new selection option input (if any) may then be retained as metadata in operation 320. Ranked search results may then be provided based on the changed or same search terms and changed or current selection options (if any) in operation 312. The search results may continue to be refined based on new or changed selection option input and/or new or changed search terms until the search is exited.

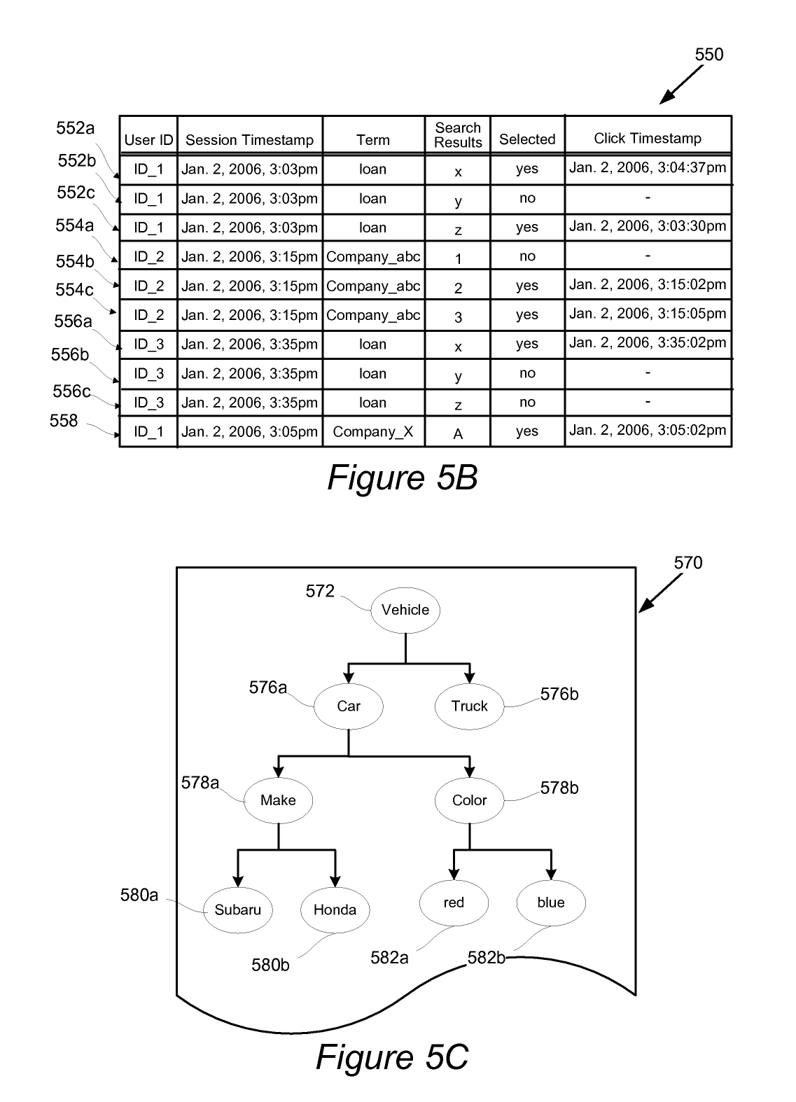

Context facets and related selection options may be obtained in any suitable manner. For example, the search and context server 206 may obtain context facets and related selectable options for particular search terms based on information that has been previously collected and retained in association with particular search terms and/or search results, e.g., web pages. In a specific example, when new facets and/or related new selection options are received from a user for a first search query, such new facets and/or related new selection options may be retained and then be provided to a same or different user in a subsequent search query as described above with respect to FIGS. 4 and 5, for example. For the subsequent search query, the user can then select any of the new selection options. In a specific embodiment, retained new facets and/or new selection options may be associated with a particular user or group of users (e.g., from a same social network). One way is to associate the retained new facets and/or new selection options with one or more user identifiers. These new facets and/or new selection options may then only be provided for a subsequent query that is being performed by the associated particular user or a member of the particular group of users.

Facets and selection options may also be obtained by querying the user who is entering one or more search terms. For instance, a query may be provided in the form of an input box that is configured to receive user input that specifies new facets and/or new selection options as described above. A new facet and a related new selection option may be received from the user, and/or a new selection option for an available facet may be received form the user.

The facets and/or selection options may be obtained from one or more databases that associate the one or more search terms with one or more facets and/or selection options. Any suitable data structure may be utilized to associate a search term with a facet and related selection options. FIG. 5A illustrates an example context data structure 500 for associating a search term with a facet and related selection options in accordance with one embodiment of the present invention. As shown, the context data structure 500 includes entries 502a-e for search term “car” and entries 504a-d for search term “restaurant.” Each entry is also associated with a specific facet and set of related selection options. For example, the entry 502a associates the “car” search term with a color facet that includes selection options red, blue etc. Although selection options are shown as text strings, other types of selection options and related facets, such as links, images, video, or audio files, may be used. Example of selection options for a facet that pertains to an advertisement category may include selectable links, such as different advertisement links.

Facets and selection options may also be based on search information that is collected and retained from a plurality of searches or search results objects, such as web pages. Useful search information can include anchor texts for web pages, user tags for web pages (e.g., entered through service providers that utilize tags, like de.licio.us tagging available from http://de.licio.us or a photo service such as flickr.com), click queries (e.g., queries for which this page's URL was clicked), and view queries (e.g., queries for which this page's URL was viewed).

A search database(s) may take any suitable form for retaining search information, some of which may be useful for determining facets and selection options for search terms and related search results. FIG. 5B illustrates an example user search database 550 in accordance with one implementation of the present invention. As shown, the user search database 550 includes a plurality of entries 552a˜552c for a first search by a first user ID_1, entries 554a˜554c for a second search by a second user ID_2, entries 556a˜556c for a third search by a third user ID_3; and entry 558 for a fourth search by the same user ID_1. Of course, each search would more typically include a higher number of entries than shown in FIG. 3A. An abbreviated list of search results is illustrated for each search in FIG. 5B for simplification purposes. Additionally, the illustrated database 550 is merely an example, and such a database may include any number and type of fields for tracking individual searches and search results for a plurality of search sessions.

Each entry relates various parameters of a particular user's search for a particular search term and various characteristics of a search result that is found in response to such search and search term. In the illustrated example, each entry may include a user identifier (ID), session timestamp, search term, a search result identification, whether such search result was clicked by the user, and the timestamp for such click. Alternatively, each entry may include a user ID and a plurality of searches that each includes a date, one or more search term(s) and their corresponding search results and related information. There are a diverse number of arrangements that could be used for search information. The user search information may include other types of data, such as the rank of the selected result among all of the search results, a category for the search term, etc (not shown).

The user ID may correspond to any characteristic associated with the searcher, and the search may be a person or an automated entity. This ID may be associated directly with some form of a user's identity, associated with the browser through which the user is requesting a search, or a search client that is running on the user's device. By way of example, the user ID may be obtained from a browser or user cookie, e.g., which may be associated with the search when the user is logged into the particular search service provider. Alternatively, the user ID may take the form of an identity associated with the device which the user is using for their search. Examples of a device identity include IP (internet protocol) addresses or MAC (media access control) addresses.

The search term (or view query for the associated search result) corresponds to a search term that was used in a specific search. A specific search may include more than one search term, which may be included in the same or a different entry of the user search database. In the present example, a separate entry may be formed for each search term and search result pair.

A “no” in the selected field indicates that the related search result was not selected by the user, while a “yes” in the selected field indicates that the related search result was selected by the user. Thus, when a search result is associated with a “yes” selection field, the associated search term is defined as a click query for which the search result was selected. A search result will tend to have a plurality of search terms for which they are selected by various users.

The facets and/or selection options may also be obtained from metadata, or a data structure, or a format that was previously associated with the one or more search terms or one or more search results that are related to the one or more search terms (e.g., via search database 550). In one implementation, facets and related selection options may be obtained based on information that is obtained form one or more web crawlers, which are configured to collect a large number of web objects or search results, such as web documents, and compile metadata for such search results. For example, if a search term is related to search results with a particular structure, the structure can be retained as metadata for such search results and serve as a basis for the facets and selection options for search terms related to such search results.

A web object, such as a web document, may have any suitable structure for determining facets. By way of examples, a microformat or XML (extensible markup language) structured document may be utilized. FIG. 5C is a diagrammatic representation of a web document 570 with a structured format from which facets and selection options may be determined for related search terms. As shown, the web document includes a hierarchical structure with a top “vehicle” element 572. The “vehicle” element 572 has a first “car” sub-element 576a and a second “truck” sub-element 576b. The “car” sub-element 576a has its own “make” sub-element 578a and “color” sub-element 578b. The “make” sub-element 578a includes a “Subaru” sub-element 580a and a “Honda” sub-element 580b, while the “color” sub-element includes the “red” sub-element 582a and “blue” sub-element 582b.

If a search term “car” is used, it may be determined that web document 570 is associated with such search term and includes a related and likely relevant “car” element 572 based on the structure of such document 570. Accordingly, the underlying related “make” and “color” sub-elements 578a and 578b (with respect to the “car” sub-element 576a) can then be defined as facets for the search term “car”. The sub-elements that are below the determined “make” and “color” facets can then be used as selection options for these related facets. Thus, the “Subaru” and “Honda” sub-elements 580a and 580b can be defined as selection options for the associated “make” facet, while the “red” and “blue” sub-elements 582a and 582b can be defined as selection options for associated “color” element 578b.

In other embodiments, the context of a vertical search can be used to obtain facets and related selection options. For example, if a search query is being performed on a car website, facets may be gathered from the structure of the car website. For instance, if menus are provide for selecting color, make, etc., these menu options can be provided as facets and related selection options. Other vertical search contexts may include searches for images, videos, news, etc. In an image vertical search example, the facets and selection options may relate to images, such as common image tag types and values, image sizes, image resolution, etc.

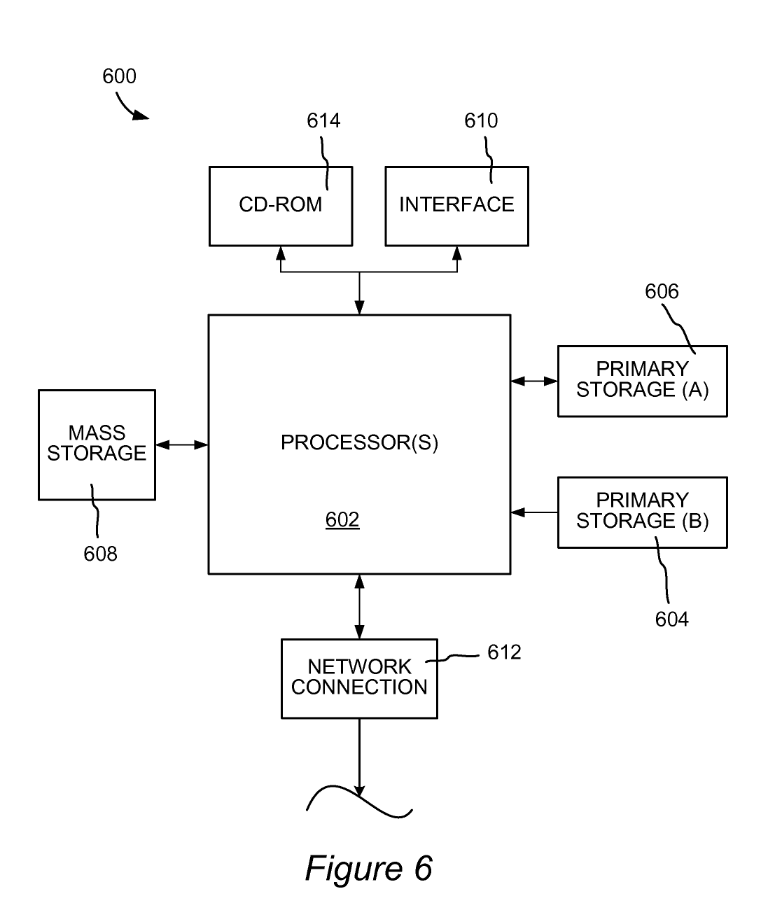

The present invention may be implemented in any suitable combination of hardware and/or software. FIG. 6 illustrates a typical computer system that, when appropriately configured or designed, can serve as a contextual search interface provider and manager. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers and microprocessors such as programmable devices (e.g., CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described above. A mass storage device 608 is also coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications network using an external connection as shown generally at 612. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store search database(s), search results metadata database(s), context database(s), etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. For example, the search context can be retained and improved over many users as well as shared by many users. The input from many users in the form of facets and/or options can provides an implicit feedback to also find out what facets and options are associated with search terms or search results. Additionally or alternatively, the context can be associated with one or more search results for the search terms. For instance, if a search term “car” has a “model” facet, a search result such as “www.honda.com” may be associated with the “car” context and “model” facet. In further implementations, the facets and their options can be used for advertisement purposes. For example, advertisement targeting may be improved based on specified facets (e.g., a “model” facet is set to “BMW”) that are associated with particular keywords (e.g., “car” keyword), e.g., by bidding on keywords based on a quantification or characterization of their associated facets and/or selection options. Therefore, the present embodiments are to be considered as illustrative and not restrictive and the invention is not to be limited to the details given herein, but may be modified within the scope and equivalents of the appended claims.

What is claimed is:

1. A method of facilitating search queries via a computer network, comprising:
after a user enters one or more search terms, obtaining one or more search facets and a plurality of selection options related to each facet based on the one or more search terms, wherein each obtained facet pertains to a specific characteristic type for the one or more search terms and each related selection option corresponds to a specific value for the specific characteristic type;
providing the one or more obtained facets and related selection options to the user so the user can select one or more selection options for the one or more search terms; and
when a search is initiated and at least one selection option has been selected by the user, providing search results based on the search terms and such at least one selection option that is selected by the user.

2. A method as recited in claim 1, wherein obtaining the one or more facets and related selection options includes one or both of the following: (i) querying the user for a new facet and, in response, receiving a new facet and a related new selection option from the user, or (ii) querying the user for a new selection option for an available facet and, in response, receiving a new selection option for the available facet.

3. A method as recited in claim 2, further comprising:
retaining an association between the one or more search terms and the new selection option and the related available or new facet that are received from the user;
for a subsequent search query, obtaining one or more search facets and a plurality of selection options related to each facet based on the one or more search terms, wherein the obtained search facets for the subsequent search include the retained new selection option and the related available or new facet;
for the subsequent search query, providing the one or more facets and related selection options, which were obtained for the subsequent search query, to the user so the user can select one or more of the provided selection options; and
when a search is initiated and at least one selection option has been selected by the user for the subsequent search, providing search results based on the search terms and such at least one selection option that is selected by the user for the subsequent search.

4. A method as recited in claim 3, wherein the retained new selection option and its related new or available facet are also associated with the user and only provided for the subsequent search if the subsequent search is performed by a same user as associated with the retained new selection option.

5. A method as recited in claim 1, wherein the one or more facets and/or one or more selection options are obtained from metadata, a data structure, or a format that was previously associated with the one or more search terms or one or more search results that are related to the one or more search terms.

6. A method as recited in claim 1, wherein the one or more facets and/or one or more selection options are obtained from a context of a vertical search for which the search terms are being entered.

7. A method as recited in claim 3, further comprising obtaining and sharing a plurality of facets and associated selection options for a plurality of users so as to improve search queries performed by such users.

8. A method as recited in claim 1, wherein at least one selection option is in the form of a link for a related facet.

9. A method as recited in claim 8, wherein the link is an advertisement link and its related facet pertains to an advertisement category.

10. A method as recited in claim 1, further comprising associating the obtained one or more facets and one or more selection options with one or more of the search results.

11. A method as recited in claim 1, further comprising using the obtained one or more facets and the selection of one or more associated selection options for search term advertisement targeting.

12. An apparatus comprising at least a processor and a memory, wherein the processor and/or memory are configured to perform the following operations:
after a user enters one or more search terms, obtaining one or more search facets and a plurality of selection options related to each facet based on the one or more search terms, wherein each obtained facet pertains to a specific characteristic type for the one or more search terms and each related selection option corresponds to a specific value for the specific characteristic type;
providing the one or more obtained facets and related selection options to the user so the user can select one or more selection options for the one or more search terms; and
when a search is initiated and at least one selection option has been selected by the user, providing search results based on the search terms and such at least one selection option that is selected by the user.

13. An apparatus as recited in claim 12, wherein obtaining the one or more facets and related selection options includes one or both of the following: (i) querying the user for a new facet and, in response, receiving a new facet and a related new selection option from the user, or (ii) querying the user for a new selection option for an available facet and, in response, receiving a new selection option for the available facet.

14. An apparatus as recited in claim 13, wherein the processor and/or memory are further configured to perform the following operations:
retaining an association between the one or more search terms and the new selection option and the related available or new facet that are received from the user;
for a subsequent search query, obtaining one or more search facets and a plurality of selection options related to each facet based on the one or more search terms, wherein the obtained search facets for the subsequent search include the retained new selection option and the related available or new facet;
for the subsequent search query, providing the one or more facets and related selection options, which were obtained for the subsequent search query, to the user so the user can select one or more of the provided selection options; and
when a search is initiated and at least one selection option has been selected by the user for the subsequent search, providing search results based on the search terms and such at least one selection option that is selected by the user for the subsequent search.

15. An apparatus as recited in claim 14, wherein the retained new selection option and its related new or available facet are also associated with the user and only provided for the subsequent search if the subsequent search is performed by a same user as associated with the retained new selection option.

16. An apparatus as recited in claim 12, wherein the one or more facets and/or one or more selection options are obtained from metadata, a data structure, or a format that was previously associated with the one or more search terms or one or more search results that are related to the one or more search terms.

17. An apparatus as recited in claim 12, wherein the one or more facets and/or one or more selection options are obtained from a context of a vertical search for which the search terms are being entered.

18. An apparatus as recited in claim 12, wherein the processor and/or memory are further configured to obtain and share a plurality of facets and associated selection options for a plurality of users so as to improve search queries performed by such users.

19. An apparatus as recited in claim 12, wherein at least one selection option is in the form of a link for a related facet.

20. An apparatus as recited in claim 19, wherein the link is an advertisement link and its related facet pertains to an advertisement category.

21. An apparatus as recited in claim 12, wherein the processor and/or memory are further configured to associate the obtained one or more facets and one or more selection options with one or more of the search results.

22. An apparatus as recited in claim 12, wherein the processor and/or memory are further configured to use the obtained one or more facets and the selection of one or more associated selection options for search term advertisement targeting.

23. At least one computer readable storage medium having computer program instructions stored thereon that are arranged to perform the following operations:
after a user enters one or more search terms, obtaining one or more search facets and a plurality of selection options related to each facet based on the one or more search terms, wherein each obtained facet pertains to a specific characteristic type for the one or more search terms and each related selection option corresponds to a specific value for the specific characteristic type;
providing the one or more obtained facets and related selection options to the user so the user can select one or more selection options for the one or more search terms; and
when a search is initiated and at least one selection option has been selected by the user, providing search results based on the search terms and such at least one selection option that is selected by the user.

24. At least one computer readable storage medium as recited in claim 23, wherein obtaining the one or more facets and related selection options includes one or both of the following: (i) querying the user for a new facet and, in response, receiving a new facet and a related new selection option from the user, or (ii) querying the user for a new selection option for an available facet and, in response, receiving a new selection option for the available facet.

25. At least one computer readable storage medium as recited in claim 24, wherein the computer program instructions stored thereon that are further arranged to perform the following operations:
retaining an association between the one or more search terms and the new selection option and the related available or new facet that are received from the user;
for a subsequent search query, obtaining one or more search facets and a plurality of selection options related to each facet based on the one or more search terms, wherein the obtained search facets for the subsequent search include the retained new selection option and the related available or new facet;
for the subsequent search query, providing the one or more facets and related selection options, which were obtained for the subsequent search query, to the user so the user can select one or more of the provided selection options; and
when a search is initiated and at least one selection option has been selected by the user for the subsequent search, providing search results based on the search terms and such at least one selection option that is selected by the user for the subsequent search.

26. At least one computer readable storage medium as recited in claim 25, wherein the retained new selection option and its related new or available facet are also associated with the user and only provided for the subsequent search if the subsequent search is performed by a same user as associated with the retained new selection option.

27. At least one computer readable storage medium as recited in claim 23, wherein the one or more facets and/or one or more selection options are obtained from metadata, a data structure, or a format that was previously associated with the one or more search terms or one or more search results that are related to the one or more search terms.

28. At least one computer readable storage medium as recited in claim 23, wherein the one or more facets and/or one or more selection options are obtained from a context of a vertical search for which the search terms are being entered.

29. At least one computer readable storage medium as recited in claim 23, wherein the computer program instructions stored thereon that are further arranged to obtain and share a plurality of facets and associated selection options for a plurality of users so as to improve search queries performed by such users.

30. At least one computer readable storage medium as recited in claim 23, wherein at least one selection option is in the form of a link for a related facet.

31. At least one computer readable storage medium as recited in claim 30, wherein the link is an advertisement link and its related facet pertains to an advertisement category.

32. At least one computer readable storage medium as recited in claim 23, wherein the computer program instructions stored thereon that are further arranged to associate the obtained one or more facets and one or more selection options with one or more of the search results.

33. At least one computer readable storage medium as recited in claim 23, wherein the computer program instructions stored thereon that are further arranged to use the obtained one or more facets and the selection of one or more associated selection options for search term advertisement targeting.
